(19) United States
(12) Patent Application Publication
(10) Pub. No.: US 2025/0029331 A1
(43) Pub. Date: Jan. 23, 2025

(54) METHOD, APPARATUS AND COMPUTER PROGRAM PRODUCT FOR BUILDING AND CONFIGURING A MODEL OF A THREE-DIMENSIONAL SPACE SCENE

(71) Applicant: BOE TECHNOLOGY GROUP CO., LTD., Beijing (CN)

(72) Inventors: Zhe ZHANG, Beijing (CN); Danfeng ZHU, Beijing (CN); Naifu WU, Beijing (CN)

(73) Assignee: BOE TECHNOLOGY GROUP CO., LTD., Beijing (CN)

(21) Appl. No.: 18/547,193

(22) PCT Filed: Feb. 28, 2022
(86) PCT No.: PCT/CN2022/078393

§ 371 Date: Aug. 21, 2023

(51) Int. Cl. G06T 17/05; G06F 3/04815

(52) U.S. Cl. CPC G06T 17/05; G06F 3/04815

(57) ABSTRACT

Embodiments of the present disclosure provide a method, apparatus, and a computer program product for building a model of a three-dimensional space scene. In the method embodiment, a configuration of a user for one or more rendering effects to be presented for the three-dimensional space scene is received; a basic model of the three-dimensional space scene is acquired; the configuration for the one or more rendering effects is parsed to determine a configuration for the basic model; and the basic model is processed according to the determined configuration for the basic model.

### CROSS REFERENCE TO RELATED APPLICATION

This application claims the benefit of International Application No. PCT/CN2022/078393, filed Feb. 28, 2022. The entire content of the above-referenced application is hereby incorporated by reference.

### TECHNICAL FIELD

The present disclosure relates to multi-dimensional scene modeling technology, and more particular to a method, apparatus and a computer program product for building and configuring a model of a three-dimensional space scene.

### BACKGROUND

In today's field of digital twins and that related to visualization application, a three-dimensional scene application is widely used. At present, there are many three-dimensional engines corresponding to three-dimensional scenes, which can help a research and development of business application. However, due to a virtualization attribute of the three-dimensional scene itself, extremely cumbersome configurations and operations are required during an actual development and building of the three-dimensional scene. Therefore, it is necessary to design a scheme to simplify a procedure of building and configuring the three-dimensional scene, so as to make the building and configuring of the three-dimensional scene to be more convenient.

### SUMMARY

The embodiments of the present disclosure provide a method and apparatus for building and configuring a model of a three-dimensional space scene, and a computer program product.

According to a first aspect of the present disclosure, the present disclosure provides a method for building a model of a three-dimensional space scene, including: receiving a configuration of a user for one or more rendering effects to be presented for the three-dimensional space scene; acquiring a basic model of the three-dimensional space scene; parsing the configuration for the one or more rendering effects to determine a configuration for the basic model; and processing the basic model according to the determined configuration for the basic model.

In an embodiment of the present disclosure, the method may further comprise: providing a first configuration interface which comprises an item indicating the configuration for the one or more rendering effects; and receiving, via the first configuration interface, the configuration input by the user for the one or more rendering effects.

In an embodiment of the present disclosure, the method may further comprise: maintaining a group of configuration file templates, wherein a configuration file template comprises a configuration rule for the one or more rendering effects to be presented for the three-dimensional space scene; receiving a setting of the user for configuration parameters in a given configuration file template in the group of configuration file templates: generating, based on the setting input by the user for the configuration parameters in the given configuration file template, a configuration file indicating the configuration of the user for the one or more rendering effects; and determining the configuration for the basic model by parsing the configuration file.

In an embodiment of the present disclosure, the configuration of the user for the one or more rendering effects may comprise one or more pictures determined to be applied to the one or more rendering effects by the user, and parsing the configuration for the one or more rendering effects to determine a configuration for the basic model may comprise: determining how to apply the one or more pictures to the basic model according to the configuration for the one or more rendering effects.

In an embodiment of the present disclosure, processing the basic model may comprise: performing image processing on the one or more pictures; and presenting the processed one or more pictures in the basic model.

In an embodiment of the present disclosure, parsing the configuration for the one or more rendering effects to determine a configuration for the basic model may comprise: determining a configuration for one or more attribute parameters of the basic model, based on the configuration for the one or more rendering effects.

In an embodiment of the present disclosure, the one or more rendering effects may comprise a time-varying dynamic effect. In an embodiment of the present disclosure, the method may further comprise: generating the model of the three-dimensional space scene by processing the basic model.

In an embodiment of the present disclosure, the method may further comprise: acquiring basic data of the three-dimensional space scene; and generating the basic model of the three-dimensional space scene based on the basic data.

In an embodiment of the present disclosure, the method may further comprise: providing a second configuration interface which comprises a group of adjustable items, wherein each adjustable item indicates a rendering effect to be presented for one or more components in the generated model of the three-dimensional space scene; receiving, via the second configuration interface, a configuration of the user for at least one adjustable item; parsing the configuration of the user for the at least one adjustable item for at least one component to determine a configuration for the at least one component; and adjusting the at least one component according to the determined configuration for the at least one component.

In an embodiment of the present disclosure, the method may further comprise: providing a third configuration interface which comprise a group of adjustable items, wherein each adjustable item indicates a scene effect that can be used for one or more components in the generated model of the three-dimensional space scene; receiving, via the third configuration interface, a configuration of the user for at least one plug-in item of at least one component of the one or more components; and applying a corresponding scene effect to the at least one component according to the configuration of the user for the at least one plug-in item.

In an embodiment of the present disclosure, the method may further comprise receiving a selection of the user for at least one component in the model of the three-dimensional space scene; providing a fourth configuration interface which comprises a group of event items, wherein each event item indicates an event that can be presented at the at least one component; receiving, via the fourth configuration interface, a selection of the user for at least one event item of the one or more event items; and generating an event toolkit describing an event indicated by the selected at least one event item for the component, by using a domain-specific language.

In an embodiment of the present disclosure, the method may further comprise: providing a fifth configuration interface which comprise an option indicating one or more interaction controls and an identity list indicating one or more events described by the event toolkit; receiving, via the fifth configuration interface, a selection input by the user for an interaction control of the one or more interaction controls and a selection input by the user for an identity in the identity list indicating the one or more events; and configuring the selected interaction control for triggering an event associated with the selected identity.

In an embodiment of the present disclosure, the method may further comprise: providing a sixth configuration interface which comprises an item indicating one or more data sources in an upper layer application of the model of the three-dimensional space scene; receiving, via the sixth configuration interface, a selection of the user for at least one data source of the one or more data sources; and binding the selected at least one data source to the at least one event described by the event toolkit, so that the at least one event is to be triggered by using the selected at least one data source.

In an embodiment of the present disclosure, the method may further comprise generating a toolkit describing the binding, by using a domain-specific language.

In an embodiment of the present disclosure, the event toolkit and the toolkit describing the binding may be generated by using a cross-platform visualization configurator.

In an embodiment of the present disclosure, the method may further comprise: transmitting the generated model of the three-dimensional space scene to an associated server.

In an embodiment of the present disclosure, the method may further comprise: rendering the model of the three-dimensional space scene in the server; and forming, from pictures of the rendered model of the three-dimensional space scene, a video stream being accessible through a network resource location identity.

According to a second aspect of the present disclosure, the present disclosure provides a system for building a model of a three-dimensional space scene, comprising a memory; and at least one hardware processor coupled to the memory and including a space editor, the space editor being configured to cause the system to execute the method according to the first aspect of the present disclosure.

According to a third aspect of the present disclosure, the present disclosure provides an apparatus for building a model of a three-dimensional space scene, including at least one processor; and a memory coupled to the at least one processor and configured to store computer instructions, wherein when executed by the at least one processor, the computer instructions cause the apparatus to execute the method according to the first aspect of the present disclosure.

According to a fourth aspect of the present disclosure, the present disclosure provides a computer-readable storage medium storing computer instructions thereon, wherein when one or more processors of a computing device execute the computer instructions, the computing device is caused to execute the method according to the first aspect of the present disclosure.

The embodiments of the present disclosure allow a user to intuitively build a desired three-dimensional space scene by configuring one or more rendering effects that will be presented for the three-dimensional space scene, without having to understand model attribute configurations which are cumbersome and complicated. Therefore, it becomes more convenient to build a three-dimensional scene.

Further adaptive aspects and scopes become apparent from the descriptions provided herein. It should be understood that various aspects of the present disclosure may be implemented separately or in combination with one or more other aspects. It should also be understood that the descriptions and specific embodiments herein are intended for descriptive purposes and are not intended to limit the scope of the present disclosure.

### DESCRIPTION OF THE DRAWINGS

The drawings described herein are for a purpose of illustrating only selected embodiments, not all possible embodiments, and are not intended to limit the scope of the present disclosure, where:

FIG. 1 is a schematic diagram illustrating an exemplary graphical user interface in which an embodiment of the present disclosure can be implemented;

FIG. 2 is a block diagram illustrating a computing device capable of displaying a graphical user interface according to some implementations;

FIG. 3 illustrates a flowchart of a method for generating and configuring a model of a three-dimensional space scene according to an exemplary embodiment;

FIG. 4 is a block diagram illustrating exemplary operations in a method for creating a model of a three-dimensional space scene according to an exemplary embodiment;

FIG. 5A to FIG. 5F illustrate configuration examples for building a model of a three-dimensional space scene according to some exemplary embodiments;

FIG. 5G to FIG. 5H illustrate configuration examples for building a model of a three-dimensional space scene according to conventional ways;

FIG. 6 is a block diagram illustrating exemplary operations in a method for configuring a model of a three-dimensional space scene according to an exemplary embodiment;

FIG. 7 is a schematic diagram illustrating an interface provided in a method for configuring a model of a three-dimensional space scene according to some exemplary embodiments;

FIG. 8 is a block diagram illustrating exemplary operations in another method for configuring a model of a three-dimensional space scene according to an exemplary embodiment; and

FIG. 9 and FIG. 10 illustrate a schematic diagram of an interface provided in another method for configuring a model of a three-dimensional space scene according to some exemplary embodiments.

### DESCRIPTION OF THE EMBODIMENTS

In order to make the purposes, technical schemes and advantages of embodiments of the present disclosure more clear, technical schemes of the embodiments of the present disclosure will be described clearly and completely in conjunction with the drawings in the embodiments of the present disclosure. Obviously, the described embodiments are only part of embodiments of the present disclosure, not all of them. Based on the described embodiments of the present disclosure, all other embodiments obtained by those skilled in the art without contributing any inventive labor should still fall within the scope of protection of the present disclosure.

Hereinafter, the embodiments of the present disclosure will be described in detail in combination with embodiments with reference to the drawings. It should be noted that, in the case of no conflict, features in embodiments of the present disclosure may be combined with each other. However, it will be apparent to those skilled in the art that embodiments of the subject matter of the invention may be practiced without these specific details. In general, it is not necessary to illustrate well-known instruction instances, protocols, structures, and techniques in detail.

As described above, a three-dimensional scene application is widely used. For example, in a specific project development, a development and building of a visualization application of a large screen window interface based on a three-dimensional design engine (for example, based on Windows®) are becoming more and more common. Common three-dimensional design engines comprise, for example, CityEngine, Blender, etc. The user experience is also increasingly not limited to two-dimensional look and feel. In order to have a better user experience and value, companies are scrambling to deploy multi-dimensional applications. The foundation of multi-dimensional virtualization application is data and model. In the procedure of actual development and building of a three-dimensional scene (such as three-dimensional urban space scene), it requires extremely cumbersome configurations and operations to generate a model of the three-dimensional scene based on data and perform associated application configuring. For example, even for generation and adjustment of a very small component in a three-dimensional scene, it is necessary to configure and adjust multiple attribute parameters in a model of the scene, such as geometric attribute parameters (such as center coordinate array, vertex coordinate array, surface tangent array, and normal array, etc.), physics attribute parameters (such as linear damping, angular damping, and enabling gravity, etc.), illumination parameters (such as perspective shadow parameter, pixel color value, and pixel transparency value, etc.), and various rules (such as CGA (computer generated architecture) shape graphics syntax). Usually, a model of a three-dimensional scene is generated and configured by using three-dimensional design engines, in which there are many parameter setting and configuration items of these attributes, and syntax for the rules are complex, so that only those who have been professionally educated and trained can master its configuration and application methods. Moreover, it is slow to output a model of the three-dimensional space scene, and its process link is long.

The embodiments of the present disclosure implement visualization and virtualization of a application business of a three-dimensional scene (such as three-dimensional urban space scene). The embodiments of the present disclosure provide a function which allows a user to intuitively configure one or more rendering effects to be presented for a three-dimensional space scene, so as to build a model of the three-dimensional space scene, thus improving a speed and convenience for building a three-dimensional scene. For a generated model of a three-dimensional space scene, some embodiments of the present disclosure provide functions that allow a user to intuitively configure a rendering effect to be presented for one or more components in the model of the three-dimensional space scene in a window interface, functions that allow the user to intuitively add and configure a scene effect plug-in for the model of the three-dimensional space scene in a window interface, functions that allow the user to intuitively configure events which can be presented at one or more components of the model of the three-dimensional space scene and associated data sources used for triggering the events, and functions that allow a further rendering for the model of the three-dimensional space scene on a cloud in a window interface, so that the model of the three-dimensional space scene can be edited and rendered again conveniently and comprehensively. Embodiments of the present disclosure further provide functions that allow a generated model of a three-dimensional space scene to be called by multiple clients, and functions that allow the generated model of the three-dimensional space scene to be used across platforms, so that the model of the three-dimensional space scene can be matched to applications of a variety of terminals and platform quickly, thus enhancing a flexibility of an output of the model of the three-dimensional space scene.

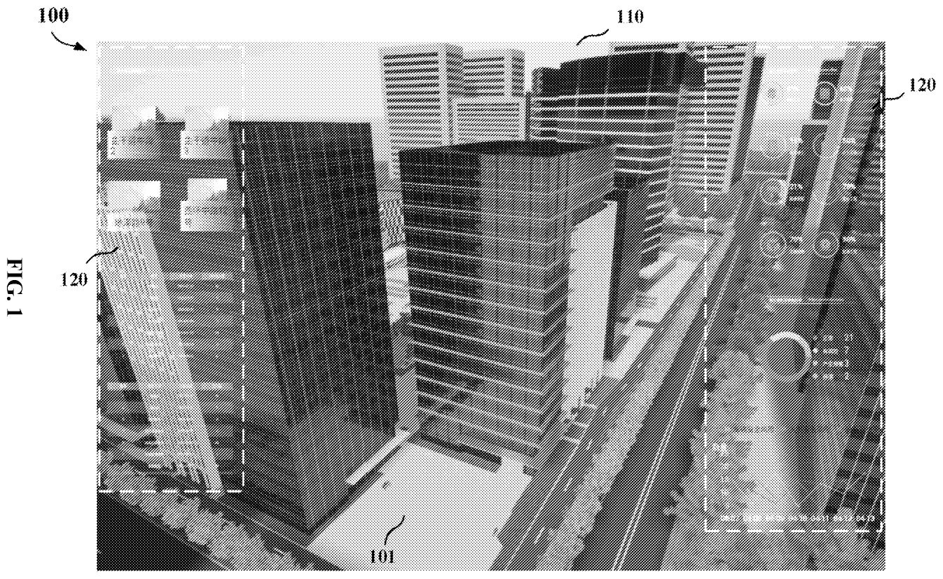

FIG. 1 is a schematic diagram illustrating an exemplary graphical user interface 100 in which an embodiment of the present disclosure can be implemented. The graphical user interface 100 comprises a visualization model area 110, which may also be referred to as a bottom layer area. As illustrated in FIG. 1, the visualization model area 110 is used for displaying a visual image of a model 101 of a three-dimensional space scene. The displayed model 101 of the three-dimensional space scene may be a model of the three-dimensional space scene built by a user, or an imported model of the three-dimensional space scene designed in advance. In case that no model of three-dimensional space scene is generated or imported (for example, an initial interface), there may be no visual image in this area. The model 101 of the three-dimensional space scene comprises one or more components, also referred to as elements. As illustrated in FIG. 1, these components/elements may be meshes in the model 101, which correspond to various solid objects in the three-dimensional space scene, such as buildings, signs, green plants, roads, terrains, waters, and skies, etc.

The graphical user interface 100 may further comprise a visualization configuration area 120 (such as the part circled by a white dotted box in FIG. 1), which may also be referred to as an upper layer area. The upper layer area may float on the bottom layer area 110. The visualization configuration area 120 provides associated data elements and control panels that can be selected and used for configuring the model 101 of the three-dimensional space scene in the bottom layer area. As illustrated in FIG. 1, the visualization configuration area 120 may comprise one or more parameter (parameter name) lists, one or more statistical data charts about specific parameters, or one or more graphical control panels.

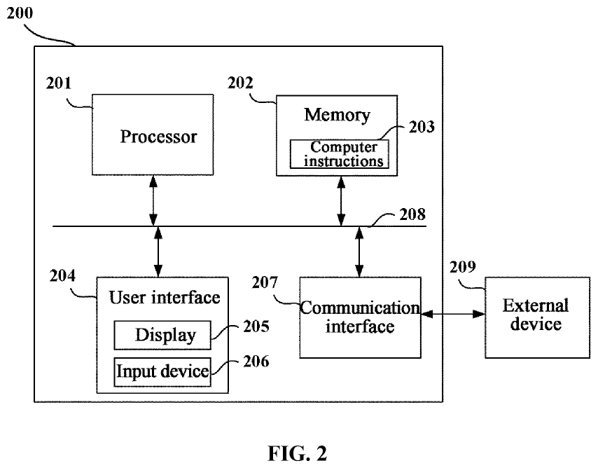

FIG. 2 is a block diagram illustrating a computing device 200 capable of displaying a graphical user interface 100 according to some implementations. The computing device 200 comprises a desktop computer, a laptop computer, a tablet computer, and other computing devices which are provided with a display and a processor capable of running a three-dimensional space scene visualization application program. The computing device 200 typically comprises one or more processors 201, a user interface 204, one or more network or other communication interfaces 207 for communicating with an external device 209 (for example, cloud server), a memory 202, and one or more communication buses 208 for interconnecting these components. The communication bus 208 may comprise circuits for interconnection and control of communication between system components.

The processor 201 is used for executing modules, programs, and/or instructions 203 stored in the memory 202, thereby executing processing operations. In some embodiments, the processor 201 may be, for example, a Central Processing Unit (CPU), a microprocessor, a Digital Signal Processor (DSP), a processor based on multi-core processor architecture, or the like.

The memory 202 or a computer-readable storage medium of the memory 202 stores programs and/or instructions for implementing methods/functions according to the embodiments of the present disclosure and related data. The memory 202 may be any type suitable for the local technical environment and may be implemented by using any suitable data storage technology. In some embodiments, the memory 202 comprises a high-speed random access memory, such as DRAM, SRAM, DDR RAM, or other random access solid-state memory devices. In some embodiments, the memory 202 comprises a non-volatile memory, such as one or more disk storage devices, optical disk storage devices, flash memory devices, or other non-volatile solid-state storage devices. In some embodiments, the memory 202 comprises one or more storage devices, such as a remote database, separated from the CPU 201.

The user interface 204 comprises a display or display device 205, and one or more input devices or mechanisms 206. In some embodiments, the input device/mechanism comprises a keyboard. In some embodiments, the input device/mechanism comprises a “soft” keyboard, which is displayed on the display 205 as needed, enabling a user to “press” a “key” that appears on the display 205. In some embodiments, the display 205 and the input device/mechanism 206 comprise a touch screen display (also referred to as a touch sensitive display).

According to an embodiment of the present disclosure, a method for building a model of a three-dimensional space scene is provided. The method comprises receiving a configuration of a user for one or more rendering effects to be presented for the three-dimensional space scene; acquiring a basic model of the three-dimensional space scene; parsing the configuration for the one or more rendering effects to determine a configuration for the basic model; and processing the basic model according to the determined configuration for the basic model.

According to an embodiment of the present disclosure, a method for configuring a model of a three-dimensional space scene is provided. The method comprises providing a second configuration interface, which comprises a group of adjustable items, wherein each adjustable item indicates a rendering effect to be presented for one or more components in the generated model of the three-dimensional space scene; receiving, via a second configuration interface, a configuration of the user for at least one adjustable item; parsing the configuration of the user for the at least one adjustable item of at least one component, to determine a configuration for the at least one component; and adjusting the at least one component according to the determined configuration for the at least one component.

According to an embodiment of the present disclosure, a method for configuring a model of a three-dimensional space scene is provided. The method comprises providing a third configuration interface which comprises a group of adjustable items, wherein each adjustable item indicates a scene effect that can be used for one or more components in a generated model of the three-dimensional space scene; receiving, via the third configuration interface, a configuration of a user for at least one plug-in item of at least one component of the one or more components; and applying a corresponding scene effect to the at least one component according to the configuration of the user for the at least one plug-in item.

According to an embodiment of the present disclosure, a method for configuring a model of a three-dimensional space scene is provided. The method comprises receiving a selection of a user for at least one component in the model of the three-dimensional space scene; providing a fourth configuration interface, which comprises a group of event items, wherein each event item indicates an event that is can be presented at the at least one component; receiving, via the fourth configuration interface, a selection of the user for at least one event item in the one or more event items; and generating an event toolkit describing an event indicated by the selected at least one event item for the component, by using a domain-specific language.

According to an embodiment of the present disclosure, a method for configuring a model of a three-dimensional space scene is provided. The method comprises providing a fifth configuration interface, which comprises options indicating one or more interaction controls and an identity list indicating one or more events described by an event toolkit; receiving, via the fifth configuration interface, a selection input by the user for an interaction control in the one or more interaction controls and a selection input by the user for one identity in the identity list indicating the one or more events; and configuring the selected interaction control for triggering an event associated with the selected identity.

According to an embodiment of the present disclosure, a method for configuring a model of a three-dimensional space scene is provided. The method comprises providing a sixth configuration interface, which comprises an item indicating one or more data sources in an upper layer application of the model of the three-dimensional space scene; receiving, via the sixth configuration interface, a selection of a user for at least one data source of the one or more data sources; and binding the selected at least one data source to at least one event described by an event toolkit, so that the at least one event is to be triggered by using the selected at least one data source.

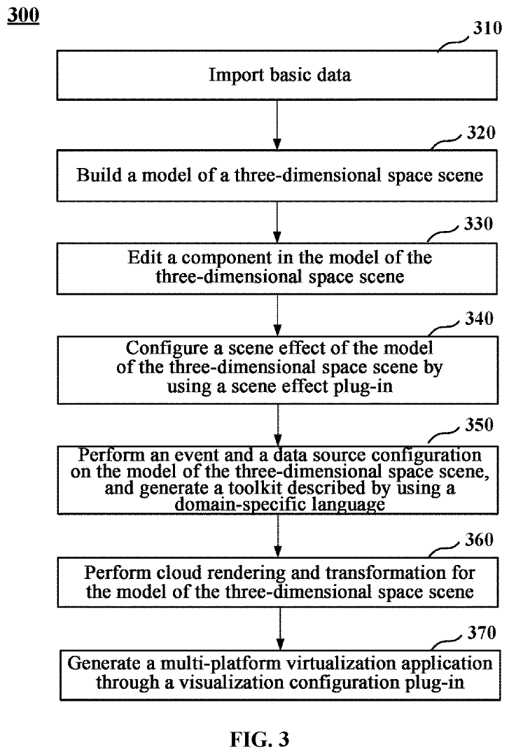

FIG. 3 illustrates a flowchart of a method for building and configuring a model of a three-dimensional space scene according to an exemplary embodiment. The method 300 may be implemented by the computing device 200 shown in FIG. 2. The method 300 may also be implemented by computer-readable instructions, which are executed by one or more processors, so that the operation of the method 300 can be partially or completely executed by functional components (such as a space editor) for generating and configuring a model of a three-dimensional space scene. However, it should be understood that at least some of the operations of the method 300 may be deployed on various other hardware configurations. For example, the space editor may further comprise a computing device (for running suitable software stored in a memory and at least one processor), a processing device or a specific device using, for example, FPGA or ASIC, or may be implemented as part thereof Δny one of the operations described in connection with the method 300 may be executed in a sequence different from that illustrated and described or be completely omitted.

At operation 310, basic data may be imported into a model building tool. The model building tool is application/software for generating a three-dimensional graphic/image model corresponding to a real space scene based on basic data, such as Blender, CityEngine, etc. The basic data comprise Geographic Information System (GIS) data and other geographic data related to a space in the real world. The basic data may come from the data stored in a local database, or come from an external data source, such as an external data map application, municipal departments, a building supplier, or merchants stationed in a building.

Generally, these basic data are not suitable for being directly used for a generation of a three-dimensional graphic/image model. For example, there may be color deviation, geographic coordinate system deviation, interference information, three-dimensional information loss and the like in these basic data. Therefore, in some embodiments, the basic data may be processed to meet requirements for the generation of the three-dimensional graphic/image model.

In some embodiments, the basic data may be processed, such as influence correction, equalization, clipping, and the like. In some embodiments, terrain interpolation generation and corresponding editing may be performed on the basic data. In some embodiments, the basic data may be subjected to a correction for a longitude and latitude of a geographic space, so that the longitude and latitude information in the basic data matches the coordinate system in the three-dimensional model.

In some embodiments, vector data processing may be performed on some basic data. For example, some basic data may be subjected to vectorization processing firstly. These basic data comprise, for example, data indicating road centerlines, building bottoms, greening information, etc. In some embodiments, editing for attributes may be performed on some vectorized data. These attributes comprise, for example, road width, building height, scene style, etc. In some embodiments, vectorized data may be supplemented by Computer Aided Design (CAD) drawings.

At operation 320, a model of a three-dimensional space scene is created. As for problems in the existing technology as described above, embodiments of the present disclosure receive a configuration of a user for one or more rendering effects to be presented for the three-dimensional space scene, and automatically parse the configuration into a configuration for the basic model of the three-dimensional space scene, so as to build the model of the three-dimensional space scene based on the basic model. Thus, the model of three-dimensional space scene can be generated automatically, without requiring the user to perform cumbersome configuration directly for one or more attribute parameters for building the model of the three-dimensional space scene.

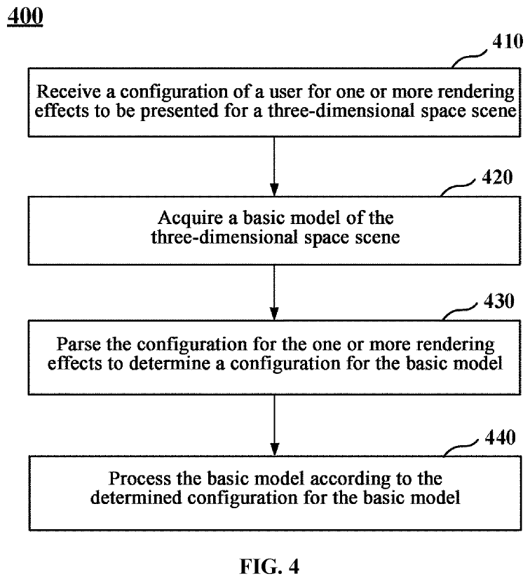

FIG. 4 illustrates a block diagram of exemplary operations in a method 400 for building a model of a three-dimensional space scene according to an exemplary embodiment. Operations 410, 420, 430, 440, 450 and 460 may be executed as part of operation 320 (for example, as a subroutine or sub-operation). The method 400 may also be implemented by computer-readable instructions executed by one or more processors, so that the operations of the method 400 may be partially or completely performed by a functional component for generating a model of a three-dimensional space scene. In some embodiments, the functional component is a Windows system-based space editor.

At operation 410, a configuration of a user for one or more rendering effects to be presented for a three-dimensional space scene may be received. A rendering effect is different from an effect image or a texture map of a mesh component in the three-dimensional model. The rendering effect refers to a rendering effect of the three-dimensional space scene that will eventually be presented to the user, that is, an image of the three-dimensional space scene that the user can intuitively see. For example, a rendering effect may comprise an image of a rendered appearance of a building in the scene, a weather image of the scene, an image of the sky in the scene, an image of a water surface in the scene, and so on. In some embodiments, the rendering effect may comprise a time-varying dynamic effect, such as a time-varying image of the sky.

In some embodiments, a first configuration interface may be provided in a graphical user interface. The first configuration interface comprises one or more configuration items indicating the one or more rendering effects. For example, one or more options indicating a rendering effect for the model scene to be achieved may be comprised in the first configuration interface. For example, the option indicates whether it is a white model, whether buildings in the scene are pure white, translucent or crystalline, whether it is provided with weather, whether it is calibrated synchronously with respect to a true time, whether a sky box is adjusted according to real events, and so on.

The user's configuration for the one or more rendering effects may be received via the first configuration interface. For example, the user may select one or more particular options for the rendering effect of the model scene, for example, a white model is used, buildings in the scene uses a pure white building, weather is not configured, synchronous calibration is adopted with respect to a true time, a sky box is adjusted according to real events, and so on.

In some embodiments, a group of configuration file templates may be maintained. A configuration file template comprises a configuration rule for one or more rendering effects to be presented for the three-dimensional space scene. The configuration file template may be defined and stored in a local memory or remote memory in advance. When the user selects to configure one or more rendering effects to be presented for the three-dimensional space scene, a configuration file template may be loaded into the space editor. Therefore, the user may edit or set a configuration parameter in the configuration file template. A configuration file may be generated based on the user's setting for the configuration parameters in a given configuration file template. The configuration file comprises or indicates the user's configuration for one or more rendering effects to be presented for the three-dimensional space scene.

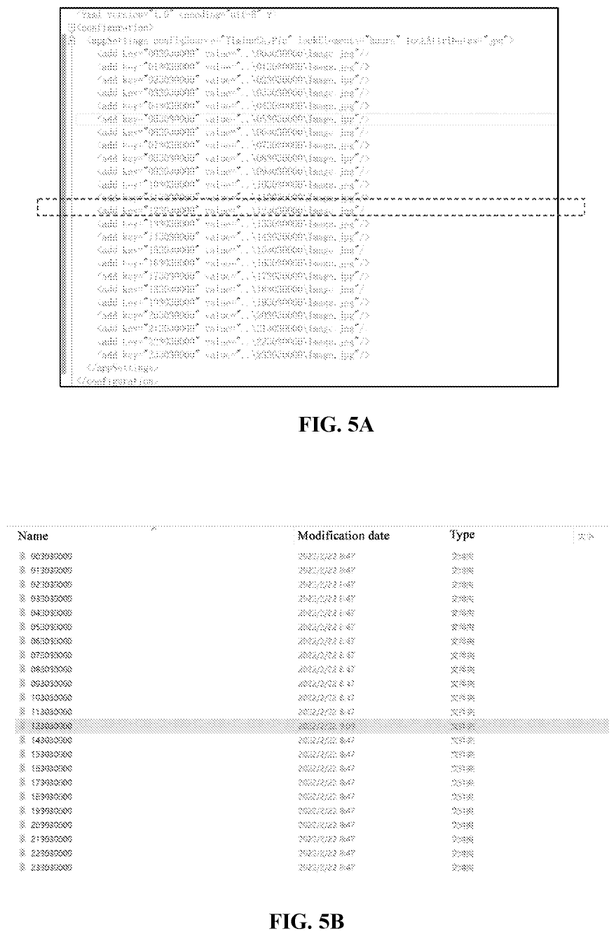

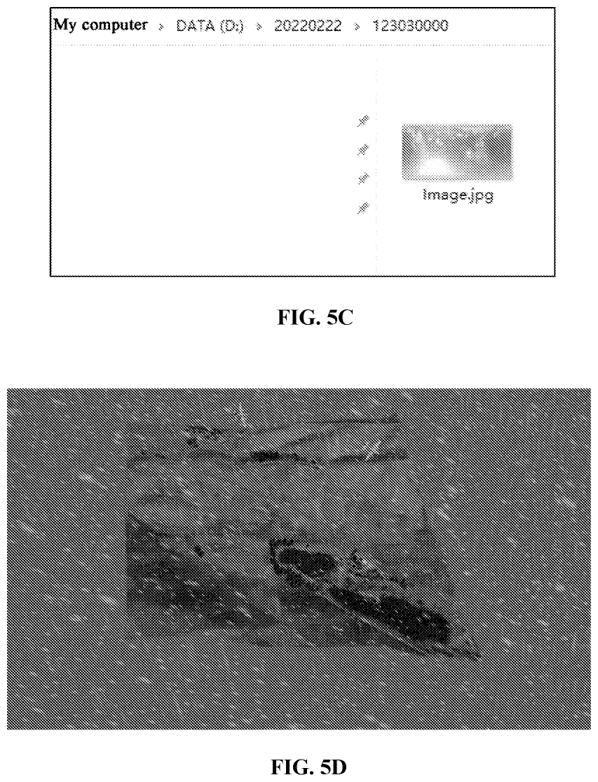

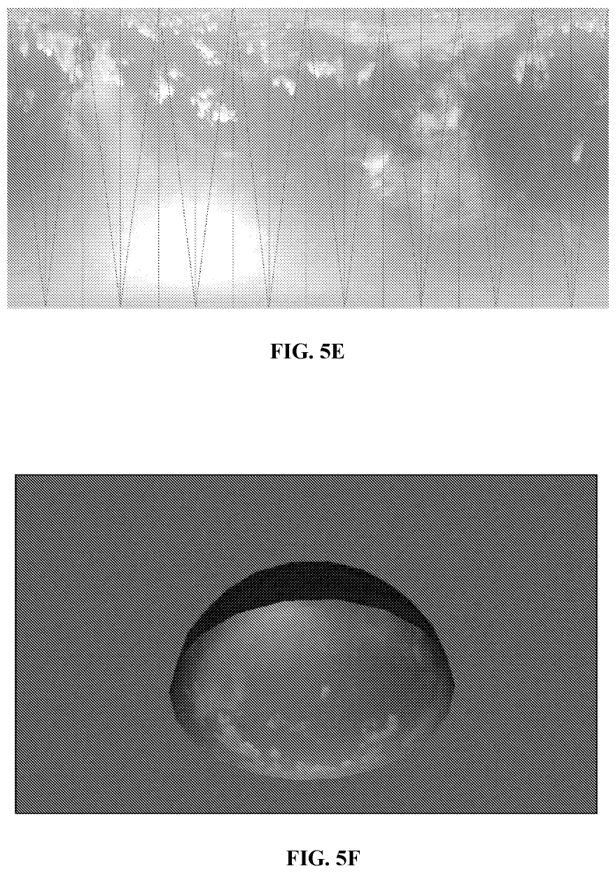

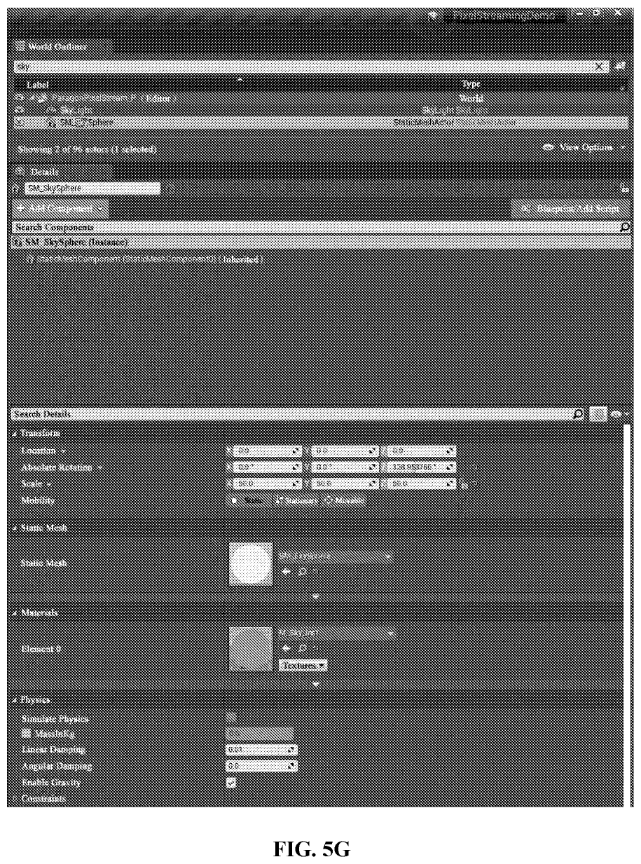

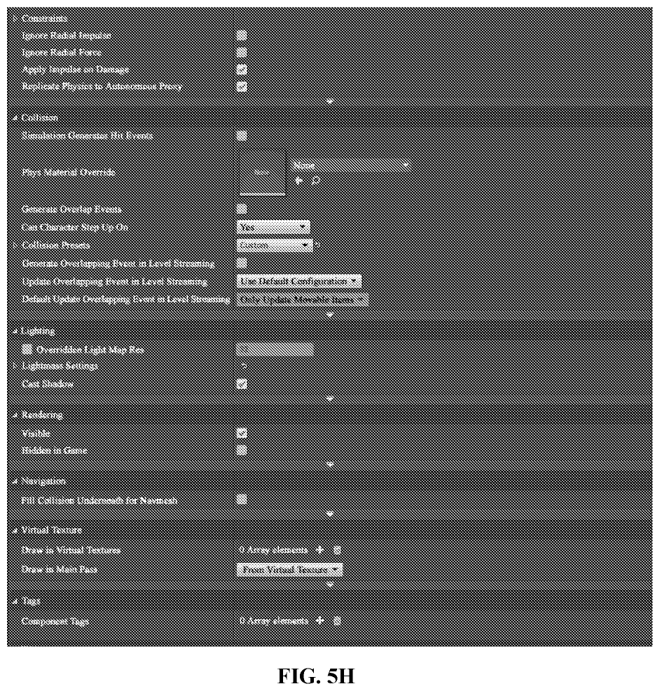

FIG. 5A to FIG. 5F illustrate examples for configuring a sky box in a building of a model of a three-dimensional space scene, according to some exemplary embodiments. FIG. 5A illustrates an exemplary configuration file according to some exemplary embodiments. The configuration file configures a sky background which varies per one hour. The configuration file may be generated based on a configuration file template for the sky background. The user may set an access path of a picture file in the template, which corresponds to a sky image corresponding to each hour, to generate a sky background of the model that the user wants to present.

FIG. 5B illustrates an example in which files of sky background pictures are stored in a folder. For example, one or more sky background pictures that can be applied to corresponding time instances are stored in each folder. The name of the folder may correspond to the time instance to which the folder is to be applied. The user may select an image of the sky background for a certain time. For example, the user may select that the image of the sky background at 12 o'clock is the picture file “image.jpg” in the file path (for example, “My computer>DATA(D:)>20220222>123030000”) illustrated in FIG. 5C. Accordingly, an access path of a picture file corresponding to the sky image for 12 o'clock in the configuration file template of the sky background may be edited or set to this path, as illustrated in the dotted box in FIG. 5A.

In some embodiments, an interface for setting a configuration file template may be provided in the graphical user interface. For example, a configuration interface may comprise one or more items for configuration for rendering effects of the sky box. The item may comprise controls, drop-down lists, etc. For example, by finding available pictures through a drop-down list, and selecting a time period through another drop-down list, the user may utilize the selected pictures as the image for the sky background of the model in the selected time period. Based on the user's settings received from the interface, a processor (for example, through a Windows space editor) may generate a corresponding configuration file from the configuration file template, such as a configuration file illustrated in FIG. 5A.

In some embodiments, the user may edit a loaded configuration profile template in a space editor directly, so as to generate a configuration file illustrated in FIG. 5A, for example.

At operation 420, a basic model of the three-dimensional space scene is acquired. The basic model comprises three-dimensional models of respective solid objects in the three-dimensional space scene. These three-dimensional models are simple geometric models without rendering effects.

In some embodiments, the basic model of the scene is built through a three-dimensional design engine tool (such as CityEngine and the like). For example, as described in operation 310, the processed basic data (such as including data of terrain/image resources, or imported roads, bottom surfaces of buildings, greening or the like) are imported into the three-dimensional design engine tool, and the basic model of the three-dimensional space scene is generated based on these basic data. In this procedure, the three-dimensional design engine tool can automatically perform floor fitting treatment and terrain leveling at the same time. In some embodiments, a channel of the three-dimensional design engine tool for outputting the basic model may be associated with the space editor, so that the basic model generated by the three-dimensional design engine tool can be imported into the space editor through a quick link.

In some embodiments, the basic model may be generated in advance and stored in a memory. When required, for example when a model of a three-dimensional space scene is to be built, the space editor may import the basic model from the memory.

At operation 430, the user's configuration for the one or more rendering effects to be presented for the three-dimensional space scene is parsed to determine configuration for one or more attributes of the basic model.

In some embodiments, the configuration for one or more attribute parameters of the basic model may be determined based on the configuration for the one or more rendering effects. For example, a mapping rule between configuration for the one or more rendering effects to be presented for the three-dimensional space scene and configuration for the one or more attributes of the model of the three-dimensional space scene may be predefined. According to the predefined mapping rules, a user's configuration for the one or more rendering effects, which is to be presented for the three-dimensional space scene, may be parsed into a corresponding configuration for an attribute parameter of the basic model. In an example, for example, the mapping rules may indicate that different values and shape syntax statements (such as CGA rules) for multiple attribute parameters of a building model correspond to respective configuration options of “whether the building in the scene is pure white, translucent or crystalline”, respectively.

In some embodiment, a user's configuration for the one or more rendering effects comprises one or more pictures determined by the user to be applied to the one or more rendering effects. The operation of parsing determines how to apply the one or more pictures to the basic model according to the configuration for the one or more rendering effects. For example, the space editor may parse a configuration file (as illustrated by FIG. 5A, for example), so as to determine corresponding pictures to be applied to a sky box in respective time periods.

In some embodiments, when the basic model is imported into the space editor through a channel, a user's configuration for the one or more rendering effects to be presented for the three-dimensional space scene is parsed. For example, one or more configuration files generated based on user configuration may be loaded in the space editor, to use the configuration files to derive the configuration for the attributes of the basic model.

In some embodiments, the configuration file indicates a configuration rule for various aspects of the basic model, including, for example, environmental rules, building rules, road rules, greening rules, etc.

At operation 440, the basic model is processed according to the determined configuration for the basic model. Based on the processing, the model of the three-dimensional space scene (such as the model 101 of the three-dimensional space scene illustrated in the visualization model area 110 in FIG. 1) can be automatically generated.

In some embodiments, parameters in the configuration file may be utilized for assigning values to attribute parameters of the basic model. In some embodiments, the basic model is subjected to operations such as stretching, splitting and adding components according to attributes configured in the configuration file. For example, if the user selects to use a European building style for a building, it may be necessary to perform a parcel stretching and a splitting of roof and elevation for a corresponding building in the basic model, and then basic texture pavement is performed.

In some embodiments, image processing may be performed on one or more pictures to be applied to the basic model; and the processed one or more pictures are presented in the basic model. FIG. 5D to FIG. 5F illustrate examples of configuring a sky box of the basic model by using pictures of the sky. FIG. 5D illustrates an exemplary image of the basic model to be processed. The basic model has not been configured with a sky box. In the example described above with reference to FIG. 5A to FIG. 5C, the user selects a rectangular sky picture of the picture file “image.jpg”. In the processing of the picture, the rectangular picture may be segmented. For example, the segment manner may be as illustrated in FIG. 5E. The cut triangles can be assembled into a positive even number quasi hemisphere with the same top (the number of sides of the positive even number polygons is greater than 6), thus forming a sky box. After the rectangular picture is segmented into triangles, the basic triangle may be stretched according to the longest model before the assembling. For example, the 32 triangles that are segmented equally in FIG. 5E may be assembled with a common vertex to form a hemisphere as illustrated in FIG. 5F. The hemisphere covers the overhead position of the basic model. Therefore, as illustrated in FIG. 5F, the basic model has a rendering effect of sky background. According to the configuration file in FIG. 5A, different sky pictures are processed as sky boxes in different time periods. Therefore, the basic model may have a time-varying sky background. It should be understood that although the sky background image is changed per hour in this example, the interval for the change of the sky background image may be set to any suitable time interval. The time interval may be set by a user or be predefined by a configuration file template.

In the example of processing a basic model, a time-varying dynamic rendering effect may be achieved by processing pictures. In an example, a user may select a configuration for a rendering effect of water surfaces (such as ponds, rivers, canals, and roads in rain, etc.) in the three-dimensional space scene. This configuration may comprise a picture of a water surface, such as a bitmap in standard JPG, PNG and other common formats. A simulated dynamic water surface ripple effect may be generated through an image processing for a picture of the water surface. In this image processing, for example, an interference source may be introduced at a random angle into a specific area of the picture, so that random radians are generated while a normal keeps at midpoint unchanged so as to simulate an effect of water ripple. As it is an operation on the bitmap itself, it does not require additional internal storage and video memory to process the display after the water ripple is simulated. The simulated effect is combined with the bitmap, which can be used as a slot of the model for rendering. In this way, it can be used in any part requiring water area without more adjustment of modeling parameters.

FIG. 5G and FIG. 5H illustrate a situation that hundreds of attribute parameters of the model of the three-dimensional space scene need to be configured in a case that the scheme is generated according to the traditional model. As illustrated in FIGS. 5G and 5H, in order to configure the sky background, it is necessary to set multiple attribute parameters or options for the sky hemisphere, including transformation related parameters, static mesh parameters, material parameters, physics parameters, collision parameters, lighting parameters, rendering parameters, navigation parameters, simulated texture parameters, tag parameters, and so on. However, in the example described above with reference to FIG. 5A to FIG. 5F, the basic model can be automatically processed by matching the basic model with the configuration file for a rendering effect of a sky, without requiring the user to configure the specific attribute parameters of the basic model. In this way, the module of the three-dimensional space scene can be generated quickly.

In some embodiments, after the processing of the basic model is completed, the generated model of the three-dimensional space scene may be output directly in a form of scene model files (for example, in a format such as universal obj and fbx) through a three-dimensional space scene building tool (for example, a space editor). For example, these files may be stored in a given space in the memory 202, such as a given folder. When the model of the three-dimensional space scene needs to be edited or configured, the scene model files may be imported into a corresponding editor.

Now returning to FIG. 3, operations of a method for editing or configuring the model of the three-dimensional space scene will be described.

At operation 330, components (elements) in the model of the three-dimensional space scene may be edited. These components/elements may be meshes in the model of the three-dimensional space scene, which correspond to various solid objects in the three-dimensional space scene, such as buildings, signs, green plants, roads, terrains, waters and sky, etc. According to an embodiment of the present disclosure, a second configuration interface is provided. The second configuration interface comprises a group of (one or more) adjustable items. Each adjustable item indicates a rendering effect to be presented for one or more components in the model of the three-dimensional space scene.

In some embodiments, if a further element editing is required for the model of the three-dimensional space scene, then through the space editor, a given folder may be monitored and the generation of a model file of the three-dimensional space scene in operation 320 may be scanned in time. When a change in the model folder is scanned, a newly generated model file may be automatically imported into an element editing list in the second configuration interface. In other embodiments, the model file of the three-dimensional space scene may be imported into the element editing list in the second configuration interface, in response to a user's input.

After the model of the three-dimensional space scene is imported into the element editing list, at least one adjustable item of one or more components (i.e., elements) in the model may be dynamically adjusted in the second configuration interface. In some embodiments, the adjusted effect may be previewed. For example, the adjustable items comprise parameters of an internal road network related to a building mesh, such as the editor is internally installed a zoom, a size adjustment, a coordinate query, an element selection, a scene rotation, support for a VR mode adjustment, and support for a gesture operation.

After a configuration for the at least one adjustable item of at least one component of one or more components input from the user via the second configuration interface is received, the processor (space editor) according to the present disclosure may parse the configuration of the user for at least one adjustable item of the at least one component, so as to determine a configuration for an attribute parameter of the at least one component. In some embodiments, the configuration for the attribute parameter of the at least one component corresponding to the configuration input of the at least one adjustable item may be determined, according to a mapping rule between the at least one adjustable item and the attribute parameters of the one or more components. In some embodiments, the configuration of the user for the at least one adjustable item of the at least one component may be parsed by performing operations similar to operations 430 and 440 described with reference to FIG. 4, and the components are adjusted accordingly to achieve re-editing of the rendering effect.

Correspondingly, the attribute parameters of the at least one component may be automatically adjusted according to the determined corresponding configuration. In this procedure, the complicated operations related to these particular attribute parameters and configurations can be performed automatically without requiring user involvement. Through the above function for element editing, the model of the three-dimensional space scene can be re-edited, optimized and adjusted in the space editor, so that a re-import and unified integration and adjustment of models from multiple sources are supported.

At operation 340, a scene effect plug-in may be configured for the model of the three-dimensional space scene, and the scene effect plug-in may be utilized for configuring the scene effect of the model of the three-dimensional space scene. According to an embodiment of the present disclosure, a third configuration interface may be provided for the user. The third configuration interface comprises a group of (one or more) adjustable items. Each adjustable item indicates a scene effect that can be used for one or more components of the model of the generated three-dimensional space scene. In some embodiments, the scene effect may be selected and configured in a procedure of element adjustment. The third configuration interface may appear in a same interface as the second configuration interface.

In some embodiments, some scene effect plug-ins may be preset in the space editor (which supports external import for a given format). Each adjustable item in the third configuration interface is associated with a corresponding scene effect plug-in. For example, adding and improving of plug-ins for some effects (such as effects of sky, atmosphere, environment, illumination, light, light film, highlighting, customized cursor, three-dimensional heating power, volume fog, etc.) may be preset in the space editor. The effect plug-ins may be editable plug-ins.

When a selection and a configuration for at least one plug-in item of at least one component in the one or more components input by a user through the third configuration interface are received, a preset effect plug-in of an associated scene may be applied. In addition, some parameters in the effect plug-in of the associated scene may be adjusted according to the configuration input of the user, so as to configure some environment and dynamic effects in the model of the three-dimensional space scene.

A given specification edited in other three-dimensional engine tools (such as products edited by UE (Unreal Engine)) may be quickly multiplexed and decoupled from the space editor through a pluggable manners (such as import/export). In a traditional scheme, only selection and configuration of plug-in are supported in a space editor, but an editing of plug-in is not supported (existing plug-ins are coded by UE or OSG (Open Scene Graphics) engines).

In some embodiments, in the procedure of adding effect plug-ins and adjusting parameters, the effect after parameter adjustment can be displayed in real time through a model preview window, so as to ensure that the data change is time-efficient.

At operation 350, configuration for an event and a data source may be performed on the model of the three-dimensional space scene, generating a toolkit described with a domain-specific language. The event refers to an occurrence of some situations/changes presented in the model of the three-dimensional space scene. In some embodiments, an event is changing a rendering effect of the three-dimensional space scene, changing an appearance of a component in the model, or changing a scene effect, etc. For example, the event comprises changing a color of a building, changing a road traffic sign, changing a simulation animation of traffic flow, changing content of video playback on a simulated advertising board, etc.

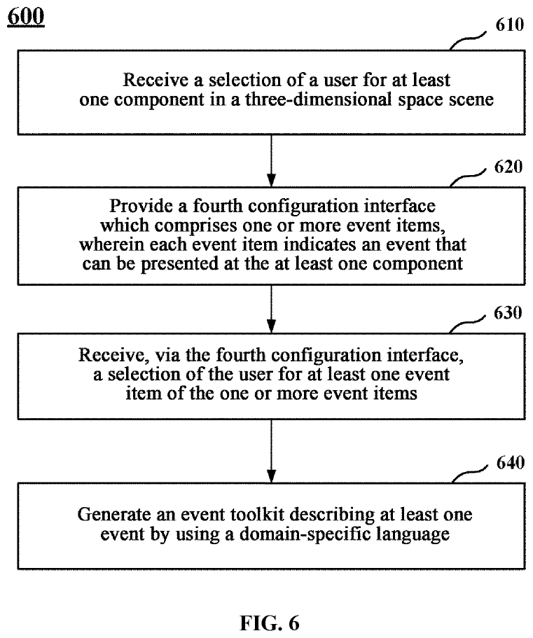

In some embodiments, after the scene effect is added and configured, configuration for a next event and data source may be performed in the space editor according to the disclosure. For example, when an input is received from a user selecting “Next Event and Data Source Configuration”, a model of the three-dimensional space scene edited in the previous step is imported into the space editor. At this time, there are two manners to display the model of the three-dimensional space scene: displaying a screenshot of the scene, or directly rendering the scene model (such as, the model 101 of the three-dimensional space scene illustrated by the visualization model area 110 in FIG. 1), as a bottom layer area of the graphical user interface for a configuration operation for the event and data source. The displaying manner may be determined according to a configuration of a used computing device. Therefore, the user can intuitively configure an event and a data source associated with the event for the displayed model of the three-dimensional space scene. FIG. 6 is a block diagram illustrating exemplary operations in a method for configuring an event for a model of a three-dimensional space scene, according to an exemplary embodiment.

At operation 610, a selection of a user for at least one component in the model of the three-dimensional space scene displayed in the bottom layer area is received. For example, the user may click an interactive node in the scene model, so as to indicate that an event will be added for the interactive node. In an example, the at least one component is a building mesh in the scene model.

At operation 620, a fourth configuration interface may be provided in the graphical user interface. The fourth configuration interface comprises one or more event items, each of which indicates an event that can be presented at the at least one component. In some embodiments, a set of events supported for the selected component may be configured in a predefined configuration file. Then, in response to receiving a selection of the user for a particular component, a list of events in the set of events supported for the particular component may be displayed in the fourth configuration interface according to the predefined configuration file. In an example, when the user selects a building mesh in the scene model, the fourth configuration interface may pop up, which contains a list of event identity (such as event IDs or names) for the building mesh. Each event identity is associated with a corresponding event that can be applied to the building mesh, such as making the building mesh to be transparent, adding a glowing frame to the building mesh, adjusting the color of the glowing frame of the building mesh, and so on. A configuration for one or more attributes of the model of the three-dimensional space scene which is used for implementing respective events may be predefined in the configuration file.

At operation 630, a selection of the user for at least one event item of the one or more event items through the fourth configuration interface may be received. For example, in the above example, the user may select to add a glowing frame to the building mesh and adjust the color of the glowing frame of the building mesh accordingly.

At operation 640, an event toolkit describing an event indicated by the selected at least one event item for the component may be generated by using a Domain-Specific Language (DSL). For example, the event toolkit may be an Application Programming Interface (API) type toolkit. The event toolkit may comprise one or more event APIs that can be called separately by the space editor or other applications as independent APIs.

Nowadays, virtualization applications are mostly data-driven, and are integrated into each end application in a form of a base or bottom layer application. Therefore, according to an embodiment of the present disclosure, a cross-platform visualization configurator (for example, developed by Flutter) may be integrated in the space editor. The cross-platform visualization configurator may be used as a plug-in of the space editor, to provide a model data-driven function (that is, data sources outside the model are used for driving events at the model) and an interaction function for event triggering/response.

Flutter is a cross-platform development framework, which takes Dart as its development language, and supports multiple development platforms (i.e., operating systems), such as Android, iOS, Linux, Web, and Windows, etc. For example, a control panel/interface of an upper layer application built by Web programs, Windows programs, Android programs, iOS programs or the like may be obtained through a transformation from a panel program developed based on Flutter.

In some embodiments of the present disclosure, the developer may determine to which type of program the panel program developed based on Flutter is to be transformed, according to a type of operating system of a control panel/interface of the upper layer application, so that a data-presenting panel layer can run in the operating system.

The advantages of Flutter lie in its speed and cross-platform nature. Flutter can be run on various operating systems, such as Android, iOS, Web, Windows, Mac, Linux, etc., and can easily transform Flutter programs into Web programs and Windows window programs through a command line tool provided by Flutter.

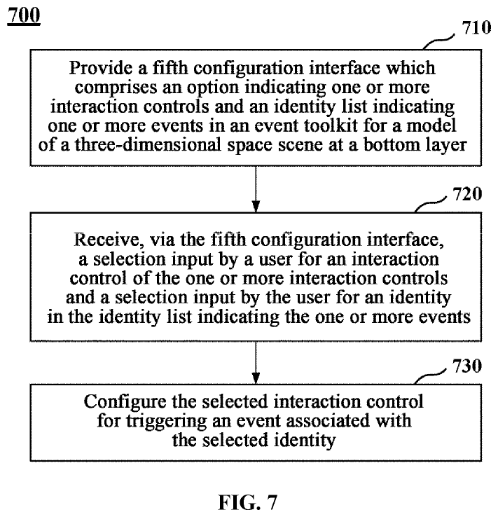

In some embodiments, a triggering/response interaction function can be configured for a given event in the model, through an event configuration function in a cross-platform visualization configuration plug-in. FIG. 7 illustrates an operation flowchart of an exemplary method.

At operation 710, the cross-platform visualization configuration plug-in may be used for providing a fifth configuration interface. The fifth configuration interface comprises an option indicating one or more interaction controls and an identity list indicating one or more events. For example, the fifth configuration interface may be a control panel/interface in an upper layer interface. The option of interaction controls may be in a form of buttons. The events indicated by the identity list may be events described in the event toolkit for a model of the three-dimensional space scene in the bottom layer interface. For example, the event toolkit may be generated through the procedure illustrated in FIG. 6. The event toolkit may comprise one or more events configured for one or more components in the model of the three-dimensional space scene in a bottom layer.

At operation 720, a selection for an interaction control of the one or more interaction controls and a selection for an identity in an identity list indicating the one or more events, which are input by the user through the fifth configuration interface, may be received. In an example, the user may select an interaction control “Click”, and the selected event identity indicates that an event “Add Glowing Frame to Building Mesh” for a given building mesh.

At operation 730, the selected interaction control may be configured for triggering an event associated with the selected identity. In this way, when the selected control is used in the upper layer interface, the associated event will be triggered. For example, in the above example, configuration can be performed so that the control “Click” can trigger the event “Add Glowing Frame to Building Mesh”. When the control “Click” is used, a corresponding building mesh can execute business logic according to the effect or attribute change defined in the API, so that a glowing frame is add on the building mesh. In some embodiments, a dedicated service may be provided in an application of a bottom layer interface to manage and call a library of APIs that the model can respond to.

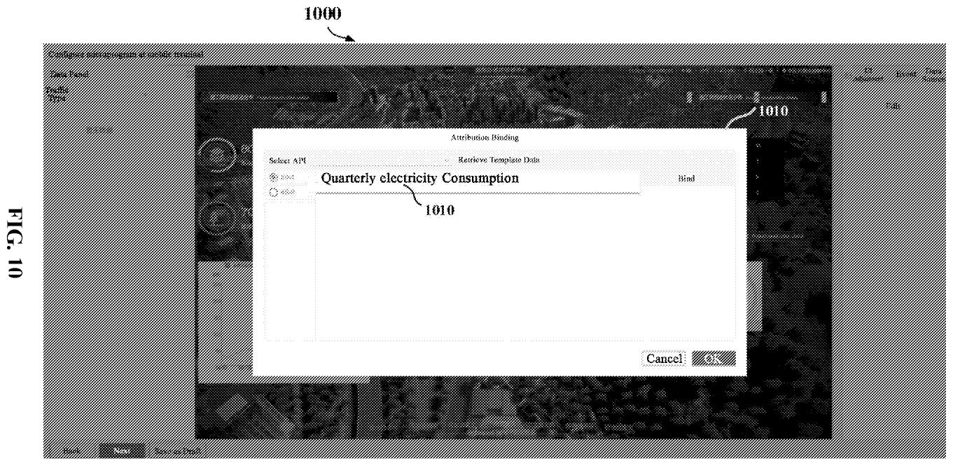

FIG. 9 illustrates a schematic diagram of a graphical user interface 900 for configuring an event interaction function. As illustrated in FIG. 9, the interface 900 comprises an operation button 902 indicating an interaction control. For example, the user may add an interaction control by clicking the button 902, for example. The interface 900 further comprises an area 904 of a drop-down identity list which indicates one or more events. For example, the user may select an event identified as “Click” from the list. When the user clicks a button “OK”, the newly added interaction control is associated with the event identified as “Click”, so that the newly added interaction control can trigger the event “Click”.

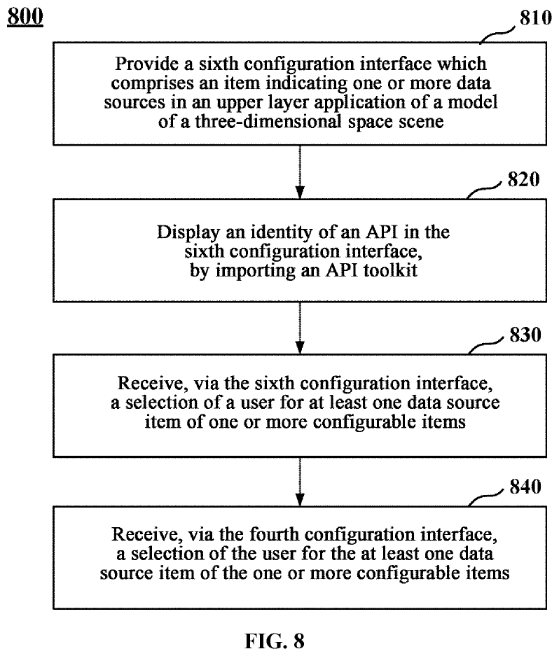

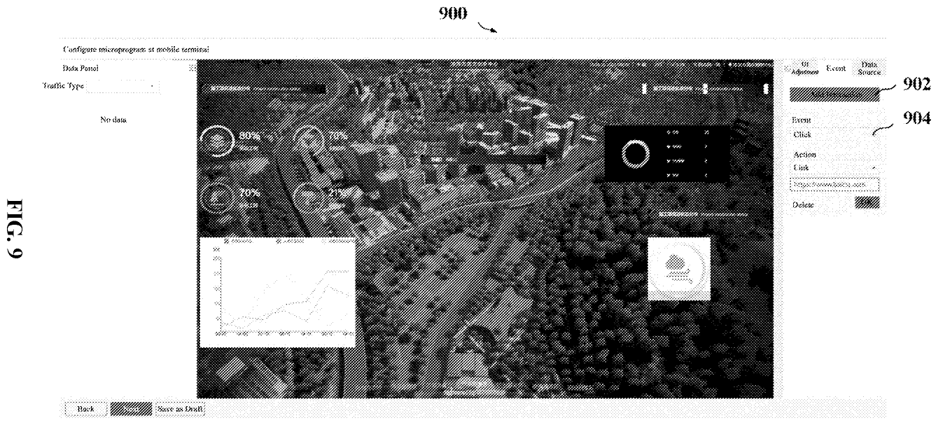

After the configuration for an event is completed, a configuration for a data source may be performed to bind a given data source for the event. In some embodiments, the event may be bound to a static or dynamic data source (such as one or more interfaces for supplying data) to drive a response for the event with data. For example, when the event is bound to an interface, an attribute change of the corresponding node in the scene model, which is associated with a configuration of the bound event, may be controlled through a change of different parameter values in the data acquired by the interface. FIG. 8 illustrates a block diagram of exemplary operations in a method for configuring a data source according to an exemplary embodiment.

At operation 810, a sixth configuration interface is provided, which comprises an item indicating one or more data sources in an upper layer application of the model of the three-dimensional space scene. For example, the sixth configuration interface may be a control panel/interface in the upper layer interface.

FIG. 10 illustrates a schematic diagram of a graphical user interface 1000 for configuring a data source. For example, when the user wants to bind a data source for a specific event, such as when the user opens a tab of “Data Source” after selecting a specific event in a tab of “Event” in FIG. 9, a user configuration interface for configuring a data source, such as a pop-up window 1010 illustrated in FIG. 9, may be provided. The pop-up window 1010 comprises an identity list 1012 indicating one or more data sources that can be applied to the event. The user may select an item in this list as the data source to be bound to the event. Although not illustrated, in some embodiments, the pop-up window 1010 may further comprise particular configuration items related to data sources, such as one or more options for configuring a trigger threshold.

At operation 820, the user may select and configure at least one data source of the one or more data sources through the sixth configuration interface.

At operation 830, when receiving the selection and configuration input by the user, the selected at least one data source may be bound to the at least one event described by the event toolkit, so that the at least one event is to be triggered by using the selected at least one data source.

In an example, a user is to bind data sources for an event “Add Glowing Frame to Building Mesh” and an event “Adjust Color of Glowing Frame of Building Mesh” of a specific building mesh in the model of the three-dimensional space scene. Therefore, the user may configure associated data sources after adding these two events for the building mesh. For example, the user may select a quarterly electricity consumption data of a building in the real space, which corresponds to the building mesh, as the data source. The data source may come from an interface provided by a property management office of the building. For example, in the configuration interface illustrated in FIG. 10, the user may select an item “Quarterly Electricity Consumption Data” in the identity list 1012. Therefore, a glowing even of the frame of the building mesh can be triggered according to the quarterly electricity consumption data of the building.

As mentioned above, the user may further configure a data source associated with “Adjust Color of glowing Frame”. For example, the user may configure thresholds of electricity consumption data for triggering various colors of a glowing frame. For example, when the electricity consumption is higher than a first threshold, the color of the glowing frame is red; when the electricity consumption is lower than a second threshold, the color of the glowing frame is green; when the electricity consumption is between the first threshold and the second threshold, the color of the glowing frame is white. For example, although not illustrated in FIG. 10, a configuration item for setting the first threshold and the second threshold may be comprised in the pop-up window 1010 illustrated in FIG. 10. This configuration item may be in a form of click button, slider control, or the like.

In some embodiments, configuration for a data source associated with an event may be implemented through an upper layer interface/panel provided by a cross-platform visualization configuration plug-in. For example, a user may configure a visualization page of an upper layer of the model of the three-dimensional space scene by dragging and dropping, such as the interfaces 900 and the interface 1000 respectively illustrated in FIG. 9 and FIG. 10, and may configure a data source and an event through the panel/interface in the visualization page. The configuration process uses, for example, the operation procedures described above with reference to FIG. 7 and FIG. 8. During the operation procedures, the configured event toolkit (for example, the event toolkit configured in the operations described with reference to FIG. 6) may be imported into the cross-platform visualization configuration plug-in. Therefore, a configurable triggered event in the event toolkit is presented on the visualization page in the upper layer. Then, the user may bind a triggering of the event to a component of the graphical user interface/panel in the upper layer, for example, through the operation procedures described above with reference to FIG. 7 and FIG. 8. By configuring an event and a data source in the interface/panel in the upper layer, the event toolkit output from the model of the three-dimensional space scene can be associated with data of the upper layer application.

In some embodiments, a complete virtualization application may be output after the configuration for an event and a data source is done. In some embodiments, the domain-specific language may be used for generating a toolkit describing the binding between the event and the data source. The toolkit generated in this binding manner by the cross-platform visual configuration plug-in may be a cross-platform toolkit which can be called by multiple terminals. For example, the toolkit may be developed on a Windows platform, but can be directly used/called by multiple other devices or terminals which use a platform of Windows, Android/iOS, web, or the like.

Now return to FIG. 3 and continue to describe operations of the method for configuring/editing a model of the three-dimensional space scene. At operation 360, the model of the three-dimensional space scene may be rendered and transformed in cloud. In some embodiments, the generated model of the three-dimensional space scene may be transmitted to an associated server, and the model of the three-dimensional space scene may be rendered in the server.

For example, when the configuration of the model of the three-dimensional space scene is done, the configured model and the toolkits pertaining to the model (such as an event toolkit, and a toolkit in which an event is bound to a data source) may be uploaded to a material repository server of an associated application open platform, for unified storage and management.

When it is need to be use the configured model of the three-dimensional space scene and toolkits, the model may be imported from the material repository server to a server for rendering. The server for rendering may be a cloud server. A set of rendering environments of a corresponding three-dimensional engine may have been configured on the server. In the rendering environments, the model of the three-dimensional space scene may be quickly rendered. Because rendering the model of the three-dimensional space scenes usually requires a large amount of storage and computational process resources, using cloud rendering can save local storage and computational process resources, thus improving rendering efficiency.

Pictures of the rendered model of the three-dimensional space scene may form a video stream. Clients of various platforms may access the video stream through a network resource location identifier (for example, Unified Resource Locator, URL). For example, when clients of various platforms (such as those using a platform of Windows, Android/iOS, web or the like) need to display a model of a three-dimensional space scene, the clients may access the URL of the video stream. Thus, pictures of the model generated through model rendering can be displayed on the clients in the form of video streaming media.

At operation 370, a multi-platform virtualization application may be generated through a visualization configuration plug-in.

In some embodiments, if various platform virtualization applications are generated through the cross-platform visualization configuration plug-in, a URL of the video stream generated for the rendered model of the three-dimensional space scene may be integrated by default into the applications which are based on the model of the three-dimensional space scene. In this way, a rendering interface can be directly accessed through an internal interface/graphical user interface/page of the application.

In addition, since various toolkits (such as an event toolkit, a toolkit in which an event is bound to a data source) and an interactive communication framework between a model layer (i.e., a module used for building a model of a three-dimensional space scene) and a visualization page layer (e.g., a module used for configuring an application based on the model of the three-dimensional space scene) are integrated when building and configuring the model of the three-dimensional space scene, an interaction operation (for example, the interaction control configured with reference to the procedure illustrated in FIG. 7) and a business logic (for example, the data source configured with reference to the procedure illustrated in FIG. 8) of a user interface in an upper layer in the application can directly trigger an event response of the model. In this way, it can quickly respond to user requirement, to provide a user with an application based on the model of the three-dimensional space scene, without requiring any additional development and configuration work on the part of the user for the application.

In some embodiments, merely a URL of a video stream of a rendered model of a three-dimensional space scene and associated toolkits (such as an event toolkit, and a toolkit in which an event is bound to a data source) are generated through the space editor and the corresponding platform. In this case, the toolkit may be downloaded and introduced by integrating a video streaming media playback component, during a development and integration procedure of various client application. In this open integration, a cross-platform communication interaction framework (such as those based on Flutter) may be integrated, to realize and apply logic and a function related to a virtualization based on the model of the three-dimensional space scene.

The particular embodiments of the present disclosure apply a business visualized and virtualized scene based on a three-dimensional space scene (such as urban space), and can quickly generate an open model of the three-dimensional space scene while matching building rules through a three-dimensional engine and data import. In addition, editing for all elements in multiple dimensions can be performed for the model of the three-dimensional space scene through the space editor. After the edited model of the three-dimensional space scene is rendered in the cloud, it can be easily matched into containers of various platforms. Embodiments of the present disclosure solve the following problems in the existing three-dimensional scene applications, such as slow generation of urban space models, long process links, and insufficient compatibility for matching with multiple cross-platform clients.

In general, various embodiments of the present disclosure may be implemented in hardware or dedicated circuits, software, logic, or any combination thereof. For example, some aspects may be implemented in hardware, while other aspects may be implemented in firmware or software that can be executed by a controller, a microprocessor, or other computing devices, but the present disclosure is not limited thereto. Although various aspects of the present disclosure can be illustrated and described as block diagrams, flowcharts, or some other graphical representations, it can be understood that these blocks, apparatus, systems, techniques, or methods described herein can be implemented in hardware, software, firmware, dedicated circuits or logic, general-purpose hardware or controllers, other computing devices, or combinations thereof.

The embodiments of the present disclosure may be executed by a computer software executable by a data processor of a computing device, such as in a processor entity, by hardware, or by a combination of software and hardware. In addition, in this regard, it should be noted that any block of a logic flow illustrated in the drawing may represent a program step, an interconnected logic circuit, block and function, or a combination of a program step and a logic circuit, block and function. Software may be stored on a physical media, such as memory chips or memory blocks implemented within processors, a magnetic media such as hard disks or floppy disks, and an optical media such as DVDs and data variant CDs thereof.

The specific embodiments of the present disclosure have been described above, but the scope of the present disclosure is not limited thereto. For those skilled in the art, the present disclosure may have various changes and variations. Any modification, equivalent replacement, improvement and the like made within the spirit and principle of the present disclosure shall be included in the scope of protection of the present disclosure.

1. A method for building a model of a three-dimensional space scene, comprising:
receiving a configuration of a user for one or more rendering effects to be presented for the three-dimensional space scene;
acquiring a basic model of the three-dimensional space scene;
parsing the configuration for the one or more rendering effects to determine a configuration for the basic model; and
processing the basic model according to the determined configuration for the basic model.

2. The method according to claim 1, further comprising:
providing a first configuration interface which comprises an item indicating the configuration for the one or more rendering effects; and
receiving, via the first configuration interface, the configuration of the user for the one or more rendering effects.

3. The method according to claim 1, further comprising:
maintaining a group of configuration file templates, wherein a configuration file template comprises a configuration rule for the one or more rendering effects to be presented for the three-dimensional space scene;
receiving a setting of the user for configuration parameters in a given configuration file template of the group of configuration file templates;
generating, based on the setting of the user for the configuration parameters in the given configuration file template, a configuration file indicating the configuration of the user for the one or more rendering effects; and
determining the configuration for the basic model by parsing the configuration file.

4. The method according to claim 1, wherein the configuration of the user for the one or more rendering effects comprises one or more pictures determined to be applied to the one or more rendering effects by the user, and
parsing the configuration for the one or more rendering effects to determine a configuration for the basic model comprises: determining how to apply the one or more pictures to the basic model according to the configuration for the one or more rendering effects.

5. The method according to claim 4, wherein processing the basic model comprises:
performing image processing on the one or more pictures; and
presenting the processed one or more pictures in the basic model.

6. The method according to claim 1, wherein parsing the configuration for the one or more rendering effects to determine a configuration for the basic model comprises:
determining a configuration for one or more attribute parameters of the basic model, based on the configuration for the one or more rendering effects.

7. The method according to claim 1, wherein the one or more rendering effects comprise a time-varying dynamic effect.

8. The method according to claim 1, further comprising:
receiving a selection of the user for at least one component in the model of the three-dimensional space scene;
providing a fourth configuration interface which comprises a group of event items, wherein each event item indicates an event that can be presented at the at least one component;
receiving, via the fourth configuration interface, a selection of the user for at least one event item of the one or more event items; and
generating an event toolkit describing an event indicated by the selected at least one event item for the component, by using a domain-specific language.

9. The method according to claim 8, further comprising:
providing a fifth configuration interface which comprises an option indicating one or more interaction controls and an identity list indicating one or more events described by the event toolkit;
receiving, via the fifth configuration interface, a selection input by the user for an interaction control of the one or more interaction controls and a selection input by the user for an identity in the identity list indicating the one or more events; and
configuring the selected interaction control for triggering an event associated with the selected identity.

10. The method according to claim 9, further comprising:
providing a sixth configuration interface which comprises an item indicating one or more data sources in an upper layer application of the model of the three-dimensional space scene;
receiving, via the sixth configuration interface, a selection of the user for at least one data source of the one or more data sources; and
binding the selected at least one data source to the at least one event described by the event toolkit, so that the at least one event is to be triggered by using the selected at least one data source.

11. The method according to claim 10, further comprising:
generating a toolkit describing the binding, by using a domain-specific language.

12. The method according to claim 8, wherein the event toolkit and the toolkit describing the binding are generated by using a cross-platform visualization configurator.

13. The method according to claim 1, further comprising:
generating the model of the three-dimensional space scene by processing the basic model.

14. The method according to claim 1, further comprising:
acquiring basic data of the three-dimensional space scene; and
generating the basic model of the three-dimensional space scene based on the basic data.

15. The method according to claim 1, further comprising:
providing a second configuration interface, which comprises a group of adjustable items, wherein each adjustable item indicates a rendering effect to be presented for one or more components in the generated model of the three-dimensional space scene;
receiving, via the second configuration interface, a configuration of the user for at least one adjustable item;
parsing the configuration of the user for the at least one adjustable item for at least one component to determine a configuration for the at least one component; and
adjusting the at least one component according to the determined configuration for the at least one component.

16. The method according to claim 1, further comprising:
providing a third configuration interface which comprises a group of adjustable items, wherein each adjustable item indicates a scene effect which can be used for one or more components in the generated model of the three-dimensional space scene;
receiving, via the third configuration interface, a configuration of the user for at least one plug-in item of at least one component of the one or more components; and
applying a corresponding scene effect to the at least one component according to the configuration of the user for the at least one plug-in item.

17. The method according to claim 1, further comprising:
transmitting the generated model of the three-dimensional space scene to an associated server.

18. The method according to claim 17, further comprising:
rendering the model of the three-dimensional space scene in the server; and
forming, from pictures of the rendered model of the three-dimensional space scene, a video stream which is accessible through a network resource location identity.

19-25. (canceled)

26. An apparatus for building a model of a three-dimensional space scene, comprising:
at least one processor; and
a memory coupled to the at least one processor and configured to store computer instructions,
wherein when executed by the at least one processor, the computer instructions cause the apparatus to execute the following operations comprising:
receiving a configuration of a user for one or more rendering effects to be presented for the three-dimensional space scene;
acquiring a basic model of the three-dimensional space scene;
parsing the configuration for the one or more rendering effects to determine a configuration for the basic model; and
processing the basic model according to the determined configuration for the basic model.

27. A computer-readable storage medium storing computer instructions thereon, wherein when one or more processors of a computing device execute the computer instructions, the computing device is caused to execute the following operations comprising:
receiving a configuration of a user for one or more rendering effects to be presented for a three-dimensional space scene;
acquiring a basic model of the three-dimensional space scene;
parsing the configuration for the one or more rendering effects to determine a configuration for the basic model; and
processing the basic model according to the determined configuration for the basic model.
